(19) United States
(12) Patent Application Publication
(10) Pub. No.: US 2006/0099934 A1
(43) Pub. Date: May 11, 2006

(54) Incoming call information notification method and apparatus using intelligent network

(75) Inventors: Chang-Hwan Song, Sungnam City (KR); Yu-Seok Kim, Sungnam City (KR); Yong-Suk Jang, Sungnam City (KR)

Correspondence Address: BIRCH STEWART KOLASCH & BIRCH, PO BOX 747, FALLS CHURCH, VA, 22040-0747, US

(73) Assignee: UANGEL Corporation

(21) Appl. No.: 11/268,564

(22) Filed: Nov. 8, 2005

(30) Foreign Application Priority Data
Nov. 9, 2004 (KR) 10-2004-91016
Sep. 28, 2005 (KR) 10-2005-90254

(51) Int. Cl. H04Q 7/22

(52) U.S. Cl. 455/412.2

(57) ABSTRACT

Disclosed herein is an incoming call information notification method in an incoming call information notification system. The method includes the steps of a subscriber setting a call forwarding condition that call forwarding be performed when a called terminal does not answer or is busy, and setting an incoming call information receiving terminal, for an intelligent network; the intelligent network notifying the incoming call information receiving terminal of the arrival of a call at the called terminal when a calling party attempts the call to the called terminal; the intelligent network attempting the call to the called terminal; and if, as a result of the attempt, the intelligent network receives information about a lack of answer or a busy state, the intelligent network notifying the incoming call information receiving terminal of call forwarding.

### BACKGROUND OF THE INVENTION

1. Field of the Invention

The present invention generally relates to an incoming call information notification method and system. In particular, the present invention relates to an incoming call information notification method, which notifies a called party's terminal (hereinafter referred to as a “incoming call information receiving terminal”; a Personal Computer (PC), a notebook computer, a Personal Digital Assistant (PDA), a portable Internet terminal, etc.), which is connected to the Internet, of incoming call information at the time of receiving an incoming call, and a system for implementing the method.

2. Description of the Related Art

In the present invention, the term “trigger” refers to an operation that is automatically performed when a database (DB) fulfills predetermined conditions.

With the popularization of telephones, telephones are used in various environments. In particular, as wireless communication is developed, many people use mobile phones (wireless communication terminals) and wireless phones are popularized in homes, so that phones are not used only in homes but can also be used anytime and anywhere.

Meanwhile, currently available Caller IDentification (CID) service is provided in such a way that an terminating switching system collects a calling number for an incoming call from an originating switching system, sends the calling number via a subscriber line prior to a subscriber's answer and causes the calling number to be displayed on the display of a called wireless communication terminal.

Accordingly, since calling number information is displayed only on the displays of wired/wireless communication terminals the users of which have subscribed to the CID service, a problem occurs in that subscribers cannot be made aware of the calling number information in the case where they are located away from the wired/wireless communication terminals for which they have subscribed to the CID service. For example, there is no way to be aware of calling number information displayed on a wireless communication terminal the user of which has subscribed to CID service and which has been left in the office, at home, or to be aware of calling number information displayed on a wireless communication terminal the user of which has subscribed to CID service and has been left in home, at the office.

Meanwhile, a Voice Mailbox Service (VMS) that operates based on a server is described below. In the case where a wireless communication terminal has been left at a specific location and a user is moving to another location and cannot answer a call, as in the case where the user has left the wireless communication terminal at home and gone to work, or has left a wireless communication terminal in the office and gone home, the mode of the terminal is automatically switched to a VMS mode when the called wireless communication terminal rings (about five to six times) and a call is not answered. In this case, a calling party must tolerate a mode switching delay and cannot be aware of the current status of a called party (whether the called party has left a terminal or cannot be aware of the arrival of a call). Although the calling party may attempt a call again, the call will be unsuccessful and the calling party must be satisfied with leaving information.

In the case where a wireless communication terminal has been left at a specific location and a user is moving to another location, as in the case where a user has left a wireless communication terminal at home and gone to work, or has left a wireless communication terminal in the office and gone home, calls can be received using a call forwarding service. However, in the case where such a call forwarding service is used as described above, while a call is being made after the call forwarding service has been set for a user's specific terminal, calls cannot be received using the original number of the terminal for which the call forwarding service has been set, so that another type of inconvenience is caused. Furthermore, a wireless communication terminal or wired phone targeted for a call forwarding service is essential and frequent call forwarding service setting is essential.

Accordingly, there is the impending need for an incoming call information notification method that notifies a called party's incoming call receiving terminal (PC, notebook, PDA, portable Internet terminal, etc.) of incoming call information at the time of receiving a call.

### SUMMARY OF THE INVENTION

Accordingly, the present invention has been made keeping in mind the above problems occurring in the prior art, and an object of the present invention is to provide an incoming call information notification method and system, which notify the incoming call information receiving terminal (a PC, a notebook, a PDA, a portable Internet terminal, etc.) of a called party, which is connected to the Internet, of incoming call information at the time of receiving an incoming call.

In order to accomplish the above object, the present invention provides an incoming call information notification method in an incoming call information notification system, including the steps of a subscriber setting a call forwarding condition that call forwarding be performed when a called terminal does not answer or is busy, and setting an incoming call information receiving terminal, for an intelligent network; the intelligent network notifying the incoming call information receiving terminal of the arrival of a call at the called terminal when a calling party attempts the call to the called terminal; the intelligent network attempting the call to the called terminal; and if, as a result of the attempt, the intelligent network receives information about a lack of answer or a busy state, the intelligent network notifying the incoming call information receiving terminal of call forwarding.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a diagram illustrating an example of the construction of an incoming call information notification system to which the present invention is applied;

FIG. 2 is a detailed flowchart illustrating an embodiment of the call forwarding process of the incoming call information notification method of the present invention in the case of no answer on a called party;

FIG. 3 is a detailed flowchart illustrating an embodiment of a call forwarding process of the incoming call information notification method of the present invention in the case where a called party is busy in a call;

FIG. 4 is a detailed flowchart illustrating an embodiment of the unconditional call forwarding process of the incoming call information notification method according to the present invention;

FIG. 5 is a detailed flowchart illustrating an embodiment of the unconditional voice (/multimedia) mailbox connection process of the incoming call information notification method according to the present invention;

FIG. 6 is a detailed flowchart illustrating an embodiment of the call termination process of the incoming call information notification method of the present invention in the case where a called party does not answer;

FIG. 7 is a detailed flowchart of the call termination process of the incoming call information notification method of the present invention in the case where a called party is busy;

FIG. 8 is a detailed flowchart of an embodiment of the unconditional call termination of the incoming call information notification method according to the present invention;

FIG. 9 is a diagram illustrating an example of the construction of another incoming call information notification system to which the present invention is applied;

FIG. 10 is a detailed flowchart illustrating an embodiment of the call forwarding process of the incoming call information notification method of the present invention, using the construction of FIG. 9, in the case where a called party does not answer;

FIG. 11 is a detailed flowchart illustrating an embodiment of the unconditional voice (/multimedia) mailbox connection process of the incoming call information notification method according to the present invention, using the construction of FIG. 9; and

FIG. 12 is a detailed flowchart illustrating an embodiment of the voice (/multimedia) mailbox connection process of the incoming call information notification method of the present invention, using the construction of FIG. 9, in the case where a called party does not answer.

### DESCRIPTION OF THE PREFERRED EMBODIMENTS

Reference now should be made to the drawings, in which the same reference numerals are used throughout the different drawings to designate the same or similar components.

The present invention defines an “incoming call information notification service,” which notifies a program on an Internet-connected called terminal belonging to a called party of incoming call information at the time of receiving an incoming call using a termination trigger method being used in an existing communication network so as to allow a termination trigger service to be conveniently and efficiently used, and in which an additional method is added to the termination trigger method.

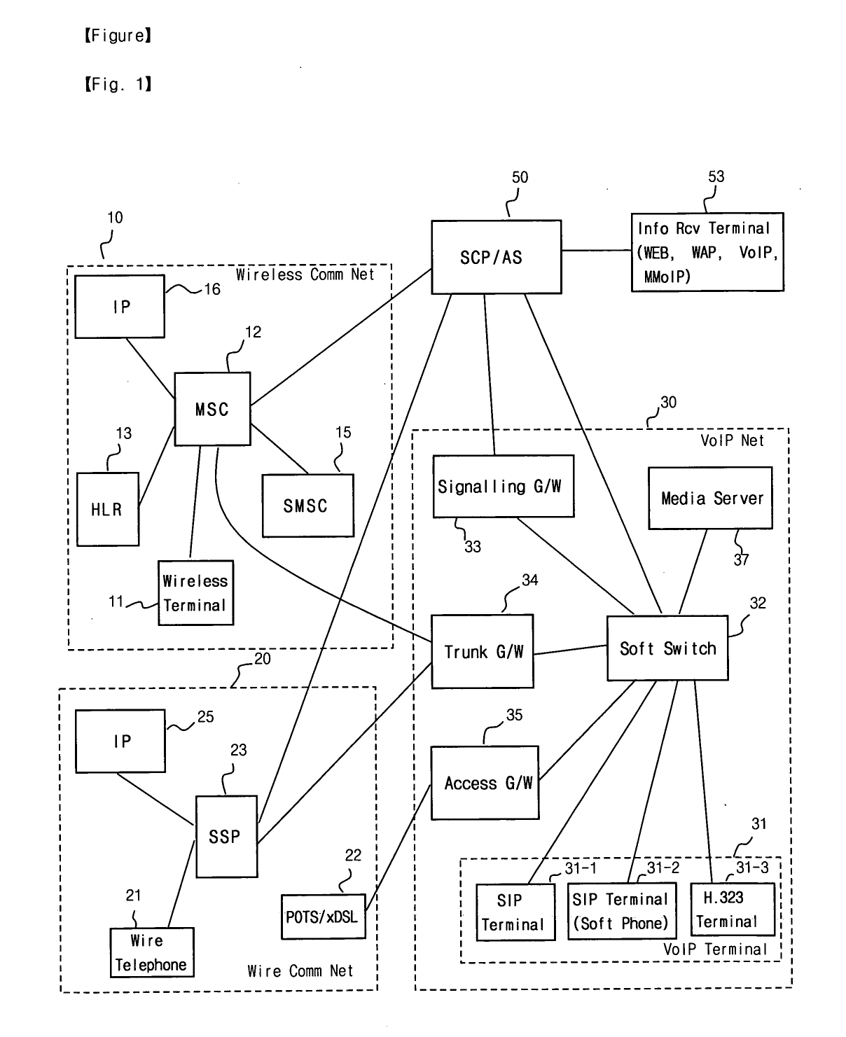

FIG. 1 is a diagram illustrating an example of the construction of an incoming call information notification system to which the present invention is applied.

The incoming call information notification service can be used after a user has accessed a service provider's wired/wireless Internet server a using a program (for example, a messenger program) installed in an incoming call information receiving terminal (Internet-connected terminal: for example, a PC, a notebook, a PDA, a portable Internet terminal, etc.) or the wired/wireless Internet, and has completed an appropriate subscription procedure through the guide screen of the wired/wireless internet server. A subscriber may check corresponding information, and forward and terminate a call using a program installed in the incoming call information receiving terminal in real time based on the set reception conditions of set information. The subscription to the service subscription can be carried out using an Automatic Response Service (ARS) connection, besides wired/wireless Internet connections, such as WEB or WAP connections.

That is, a user can use the incoming call information notification service after subscribing to the incoming call information notification service through a separate subscription procedure. Furthermore, the user can use the incoming call information notification service using a separate program (for example, a messager program) installed in the subscriber's incoming call information receiving terminal (for example, a PC, a notebook computer, a PDA or a portable Internet terminal) or the wired/wireless Internet.

The incoming call information notification service is a service that notifies a program (for example, a messenger program) installed in a subscriber's incoming call information receiving terminal (for example, a PC, a notebook, a PDA, a portable Internet terminal, etc.) of corresponding information, and forwards or terminates an incoming call according to reception conditions based on information set by the subscriber.

The incoming call information notification service may be provided in different manners for different service providers' networks (a wireless communication network, a wired communication network, a Voice over Internet Protocol (VoIP) network and a Broadband Convergence Network (BcN)), and can be used by all the wired/wireless network subscribers of each service provider equipped with service control points. For this, all of the switching system of the network service provider (for example, Mobile Switching Centers (MSCs) and Service Switching Points (SSPs)) and soft switches must support the termination trigger. Accordingly, the subscriber's termination trigger conditions are initiated by the incoming call information of the switching system or soft switch.

Basic information about a subscriber to the incoming call information notification service includes the subscriber's mobile phone number, the subscriber's home phone number, and the subscriber's office phone number, and these phone numbers can be registered after being authenticated at the time of registration. Registered information may be modified, and the modification can be performed after being authenticated.

Calling and called terminals 11, 21, 22 and 31 for the incoming call information notification service may be voice communication-enabled wired and wireless phones, Plain Old Telephone Service (POTS)/xDSL terminals, mobile communication terminals such as cellular phones or Personal Communication Service (PCS) phones, next generation mobile communication terminals such as International Mobile Telecommunication (IMT)-2000 terminals and Universal Mobile Telecommunication Service (UMTS) terminals, Personal Digital Assistants (PDAs), and VoIP terminals such as Session Initiation Protocol (SIP) terminals, soft phones and H.323 terminals. As long as calling and called terminals 11, 21, 22 and 31 can perform voice communication, they are not tied to a type of target network (wired communication network, wireless communication network, VoIP network, Next Generation Network (NGN) or BcN) 10 to 30.

Furthermore, the incoming call information receiving terminal 53 may be a PC, a notebook computer, a mobile communication terminal such as a cellular phone or PCS phone, a next generation mobile communication terminal such as a smart phone, an IMT-2000 phone or UMTS phone, a PDA, a wireless Internet (WAP/ME) terminal, a wired Internet (WEB) terminal, or a portable Internet terminal. As long as the incoming call information receiving terminal 53 can perform data communication, it is not tied to a type of target network (wired communication network, wireless communication network, VoIP network, NGN, or BcN) 10˜30.

The functions of the elements of the incoming call information notification system for the incoming call information notification service are described below.

A Service Switch Point (SSP) 23 switches the call resource management and service of the terminals 21 of the wired communication network 20.

A Mobile Switching Center (MSC) 12 switches the call resource management and service of the terminals 11 of the wireless communication network 10.

A Service Control Point/Application Server (SCP/AS) 50 controls intelligent network service, manages information about subscribers to the intelligent network service, and provides information required for call processing to the MSCs 12 and 23. Furthermore, the SCP/AS 50 provides application services converged/combined with various environments while working in conjunction with the network resources of a communication network and the Internet based on its own specifications. The VoIP network provides various additional services by processing calls and media while working in conjunction with the soft switch 32.

Intelligent Peripherals (IPs) 16 and 25 process special resources, such as tones, announcements, conference call bridge management and Text-to-Speech (TTS), that are required in a service logic control process. That is, additional intelligent network services are provided to the users/subscribers of the intelligent network service using voice or text.

A Home Location Register (HLR) 13 registers the locations of the wireless communication terminals 11, manages the information about the status of the terminals 11 and can detect the precise locations of the terminals 11. That is, the HLR 13 is a database management system that stores and manages subscriber parameters and location information for all the terminals 11 registered in its own region. The HLR 13 manages principal data such as the access capabilities of the terminals 11, a basic service, and additional services, and performs routing to called subscribers.

A Short Message Service Center (SMSC) 15 is connected to the MSC 12, plays a key role in SMS processing, sets SMS parameters, and interprets the Teleservice Identifier (TI) and destination address of an input signal and transmits them to a corresponding network element.

A POTS/xDSL 22 is equipment and a terminal that can provide a basic voice service without additional functions, such as circuit adjustment and characteristic compensation, for data transmission through an XDSL network.

A signaling gateway 33 is equipment functioning as a gateway for implementing an existing Public Switched Telephone Network (PSTN) service on an Next Generation Network(NGN), and functions to convert the signal of a signaliing System #7(SS7) into the IP signal of the NGN and transfers it to the soft switch 32.

An access gateway 35 is equipment required for the connection of the general telephone users of a wired/wireless communication network, such as a PSTN, to a packet network, such as a VoIP or VoATM network, and functions to convert the voice data of a general telephone into a form suitable for transfer to the packet network.

A trunk gateway 34 is equipment for causing a PSTN and a packet network (a VoIP or VoATM network) to work in conjunction with each other, and functions to transmit a large amount of data, which is produced on the PSTN to the packet network.

A soft switch 32 is also called a media gateway controller, and is equipment that generally causes a packet network and an existing wired/wireless communication network to work in conjunction with each other. The soft switch 32 transfers signals between heterogeneous networks, processes calls, and controls media gateways, including the access gateway 35, the trunk gateway 34, and the signaling gateway 33.

A media server 37 is a system that processes special resources, including tones, announcements, conference call bridge management and TTS required for service logic control. However, the media server 37 is different from the IP 25 for the existing PSTN in that the media server 37 provides special resources required for packet-based service logic control while working in conjunction with the soft switch 32 of the NGN. Furthermore, the media server 37 provides special resources such as a video stream that is required for the provision of the additional multimedia-based services of an NGN in the future.

The procedure of the incoming call information notification service is described in detail below.

First, the incoming call information notification service may be mainly classified into an incoming call forwarding setting service and a call termination service.

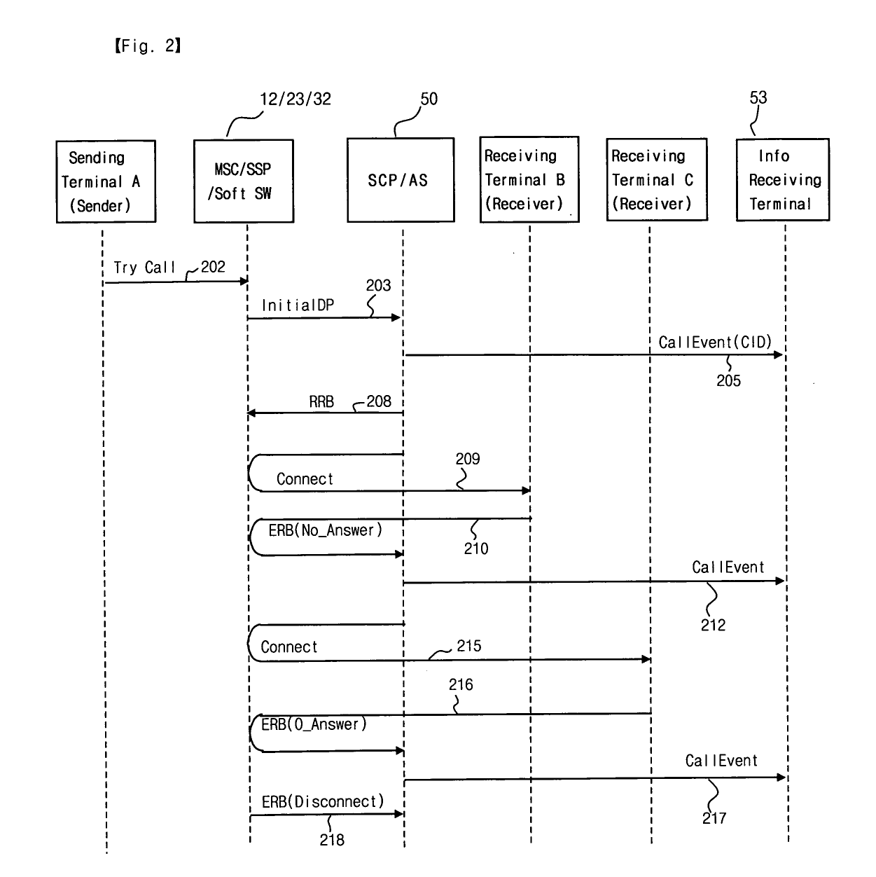

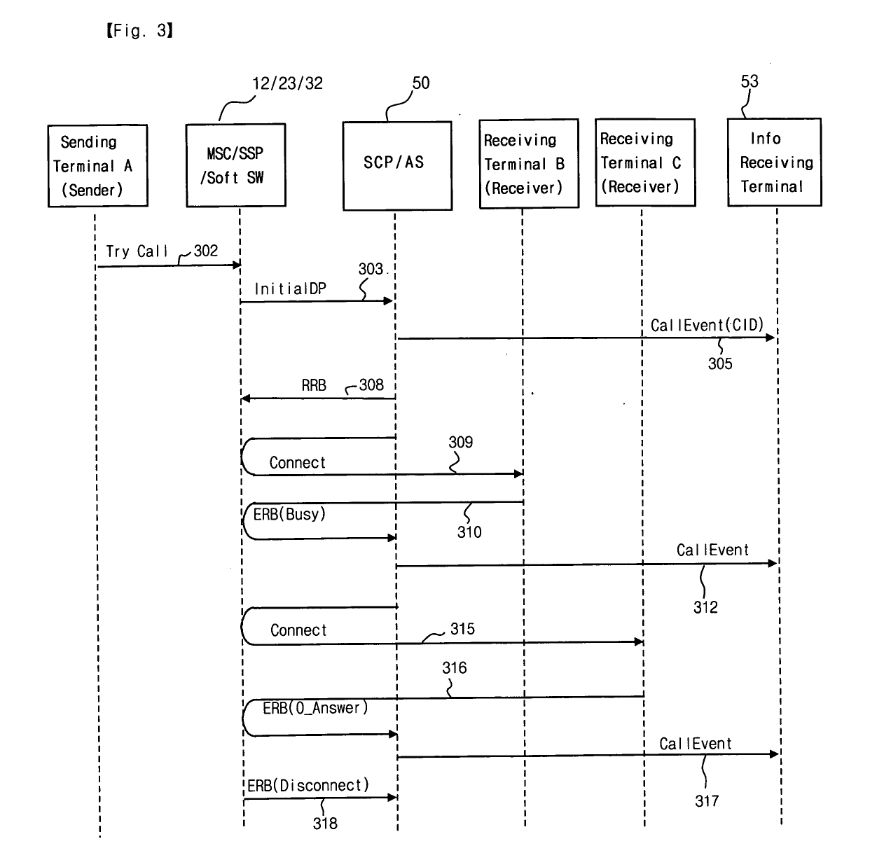

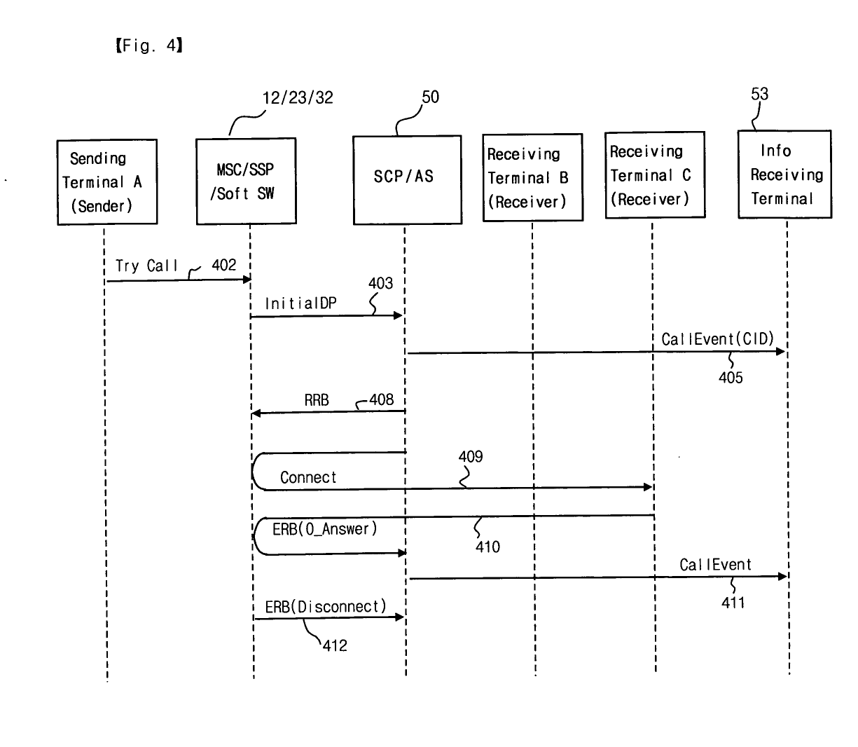

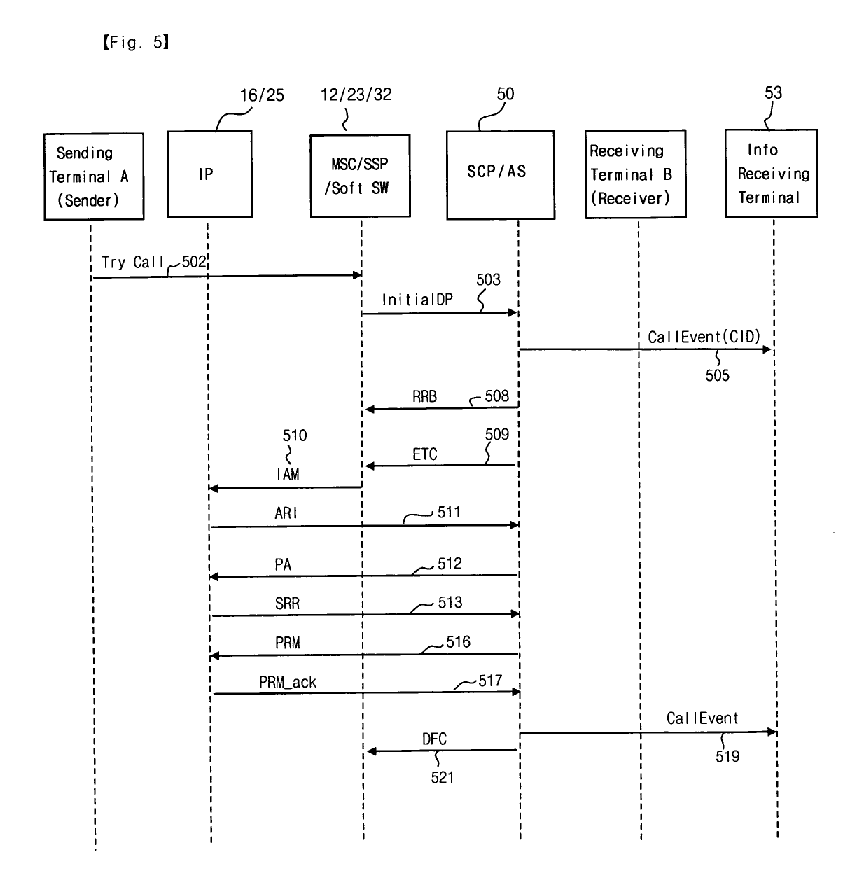

The incoming call forwarding setting service includes a “call forwarding service scenario in the case of no answer” (refer to FIG. 2) that forwards an incoming call to a registered call forwarding number if there is no answer to the incoming call and the flag “call forwarding in the case of no answer” has been set for a called subscriber; a “call forwarding service scenario for a busy line” (refer to FIG. 3) that forwards an incoming call to a registered call forwarding number if a corresponding line is busy and the flag “call forwarding in the case of a busy line” has been set for a called subscriber; an “unconditional call forwarding service scenario” (refer to FIG. 4) that forwards an incoming call to a registered call forwarding number at the time of attempting a call to a called subscriber if the flag “unconditional call forwarding” has been set for the called subscriber; a “forwarding call to voice (/multimedia) mailbox service scenario for a busy line” that performs call processing that connects an incoming call to a registered voice (/multimedia) mailbox or stores a message if a corresponding line is busy at the time of attempting a call and the flag “forwarding call to voice (/multimedia) mailbox in the case of a busy line” has been set for a called subscriber; a “forwarding call to voice (/multimedia) mailbox service scenario in the case of no answer” that performs call processing that connects an incoming call to a registered voice (/multimedia) mailbox or stores a message if there is no answer at the time of attempting a call and the flag “forwarding call to voice (/multimedia) mailbox in the case of no answer” has been set for a called subscriber; and an “unconditionally forwarding call to voice (/multimedia) mailbox service scenario” (refer to FIG. 5) that performs call processing that connects an incoming call to a registered voice (/multimedia) mailbox or stores a message at the time of attempting a call if the flag “unconditionally forwarding call to voice (/multimedia) mailbox” has been set for a called subscriber.

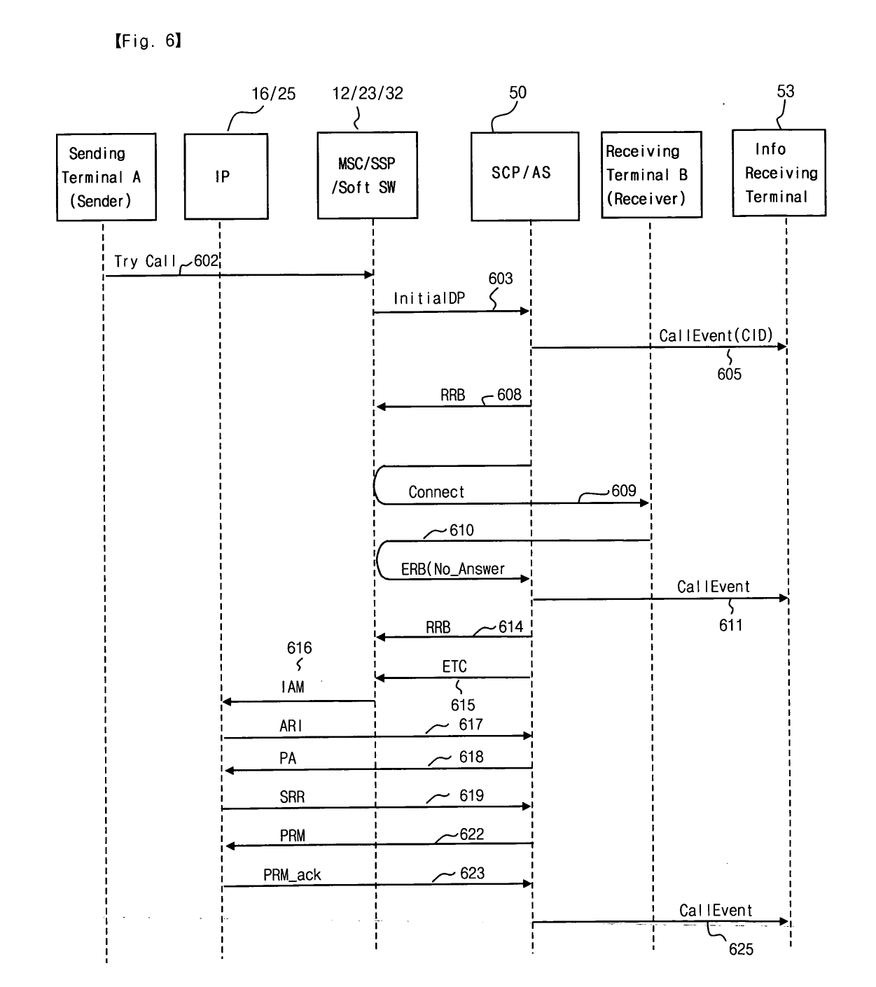

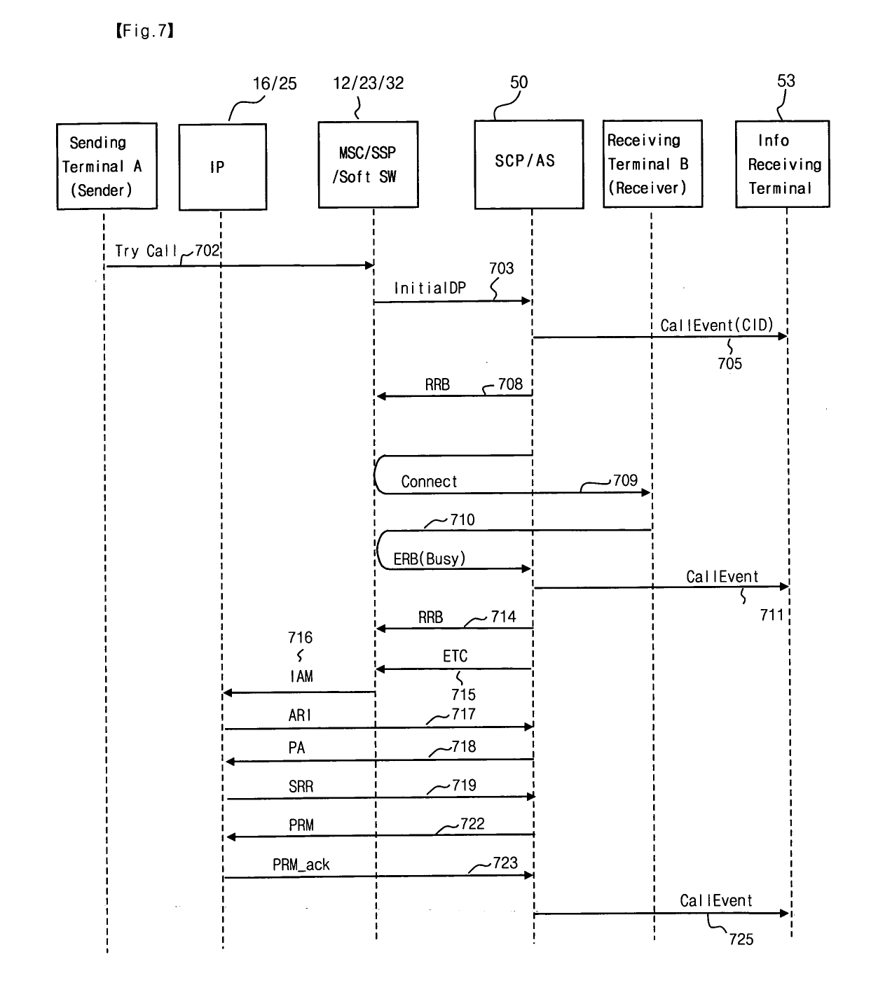

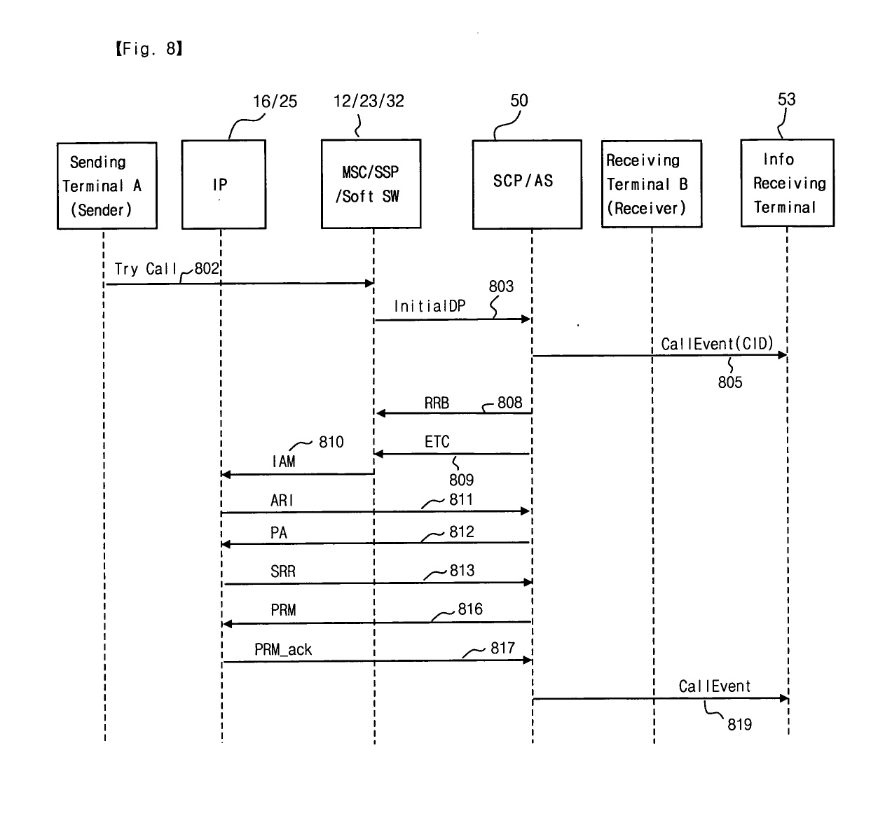

The call termination service includes a “call termination service scenario in the case of no answer” (refer to FIG. 6) that terminates a call after playing an appropriate announcement if there is no answer at the time of attempting a call and the flag “call termination in the case of no answer” has been set for a called subscriber; a “call termination service scenario for a busy line” (refer to FIG. 7) that terminates a call after playing an appropriate announcement if a corresponding line is busy and the flag “call termination in the case of a busy line” has been set for a called subscriber; and an “unconditional call termination service scenario” (refer to FIG. 8) that terminates a call after playing an appropriate announcement at the time of attempting the call to a called subscriber if the flag “unconditional call termination” has been set for the called subscriber.

There may be various methods of providing notification to a subscriber to the incoming call information notification service. These methods may include a method of notifying a subscriber of the arrival of an incoming call through the notification window of the User Interface (UI) of a user program at the time of attempting a call to a subscriber (notification window notification at the time of receiving a call); a method of providing notification of the receipt of a call through a ring tone set in the UI of a user program at the time of attempting a call to a subscriber (ring tone notification at the time of receiving a call); a method of providing notification of corresponding content through the UI of a user program at the time of receiving a new voice (/multimedia) message (new voice (/multimedia) message receipt notification); a method of notifying a subscriber of the termination of a call through the UI of a user program at the time of attempting the call to the subscriber if the subscriber has set “call termination” (call termination notification); and a method of notifying a subscriber of the forwarding of a call through the UI of a user program if the subscriber has set “call forwarding” (call forwarding notification).

Furthermore, the service subscriber can easily change a called number simply by changing the setting file of the UI of a user program, can set an operation of forwarding and terminating calls according to automatically set subscriber information when the UI of a user program has not used a logged-on computer for a predetermined period of time (operational setting during absence), and can set an operation of forwarding and terminating calls according to automatically set subscriber information when the subscriber logs out of the UI of the user program.

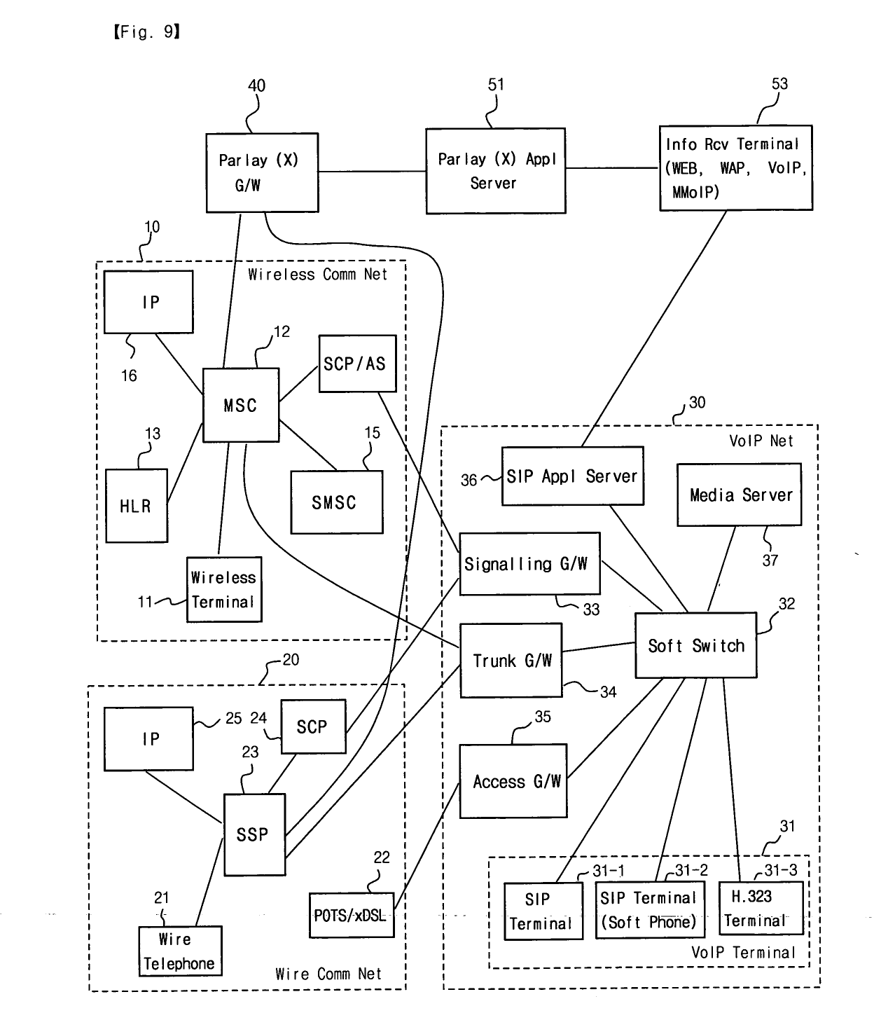

The procedure of the incoming call information notification service is described in greater detail below. Although service may be provided in different ways depending on the networks of service providers, the following descriptions are given based on the wireless communication network 10 for ease of description, in which a call processing procedure between a mobile communication switching center (MSC) 12, a SCP/AS 50 and an IP 16 is described first with reference to FIGS. 2 to 8, and a method in which a Parlay application server is used instead of the SCP/AP is subsequently described with reference to FIGS. 9 to 12.

However, it should be noted that the elements of the procedure may be replaced with other elements having the same functions depending on the service network. For example, the SCP or Parlay application server of the present invention may be replaced with various intelligent networks having similar functions.

FIG. 2 is a detailed flowchart illustrating an embodiment of the call forwarding process of the incoming call information notification method of the present invention in the case of no answer on a called party. In this case, a called subscriber sets a called number to that of terminal B, sets ‘call forwarding in the case of no answer on a called party’, and sets a call forwarding number to that of terminal C.

When a certain subscriber (calling terminal A) attempts a call to a service subscriber (terminal B) at step 202, a originating switching center (MSC) 12 notifies an SCP 50 of the initiation of the call by transmitting “InitialDP” message to the SCP 50 according to trigger information set for a called subscriber at step 203.

Thereafter, the SCP 50 notifies a program (for example, a messenger program), which has been logged in to and installed in the incoming call information receiving terminal 53 of the called subscriber, of the arrival of the call by transmitting a “CallEvent(CID)” message to the program at step 205. At this time, the information transmitted from the SCP 50 to the incoming call information receiving terminal 53 varies depending on the set information of the called subscriber.

Thereafter, the SCP 50 sets the event of the calling/called terminal by transmitting “RRB(RequestReportBCSMEvent)” message to the MSC 12 at step 208.

The SCP 50 attempts the call to terminal B by transmitting a “Connect” message to a called number at step 209. This step is performed through the MSC 12. That is, when the SCP 50 transmits the “Connect” message to the MSC 12 using the called number, the MSC 12 attempts the call to a corresponding called terminal B.

If the called terminal B does not answer (No_Answer), the MSC 12 notifies the SCP 50 of the no-answer state of the called terminal B by transmitting an “ERB(EventReportBCSM) (No_Answer)” message to the SCP 50 at step 210.

For this, the SCP 50 notifies the program (for example, a messenger program), which has been logged in to and installed in the incoming call information receiving terminal 53 of the called subscriber, of the forwarding of the call by transmitting a “CallEvent” message to the program at step 212. At this time, the information transmitted from the SCP 50 to the incoming call information receiving terminal 53 varies depending on the set information of the called subscriber.

Thereafter, the SCP 50 attempts the call to called terminal C by transmitting a “Connect” message to the call forwarding number in the case of no answer at step 215. This step is performed through the MSC 12. That is, when the SCP 50 transmits the “Connect” message to the MSC 12 using the call forwarding number, the MSC 12 attempts the call to called terminal C.

If called terminal C answers (O_Answer), the MSC 12 notifies the SCP 50 of the answer state of called terminal C by transmitting an “ERB(O_Answer)” message to the SCP 50 at step 216.

For this, the SCP 50 notifies the program (for example, a messenger program), which has been logged in to and installed in the incoming call information receiving terminal 53 of the called subscriber, of the answer to the call by transmitting a “CallEvent” message to the program at step 217. At this time, the information transmitted from the SCP 50 to the incoming call information receiving terminal 53 varies depending on the set information of the called subscriber.

When the call is released while calling terminal A is engaged in the call with called terminal C, the MSC 12 notifies the SCP 50 of the termination of the call by transmitting an “ERB(Disconnect)” message to the SCP 50 at step 218.

FIG. 3 is a detailed flowchart illustrating an embodiment of a call forwarding process of the incoming call information notification method of the present invention in the case where a called party is engaged in a call. In this case, the called subscriber sets the called number to called terminal B, sets ‘call forwarding while the called party is busy’, and sets a call forwarding number to that of called terminal C.

When a certain calling party (calling terminal A) attempts a call to service subscriber terminal B at step 302, the calling MSC 12 notifies the SCP 50 of the initiation of the call by transmitting an “initialDP” Message to the SCP 50 according to the trigger information set for the called subscriber at step 303.

Thereafter, the SCP 50 notifies the program (for example, a messenger program), which has been logged in to and installed in the incoming call information receiving terminal 53 of the called subscriber, of the arrival of the call by transmitting a “CallEvent(CID)” message at step 305. In this case, the information transmitted from the SCP 50 to the incoming call information receiving terminal 53 varies according to the set formation of the called subscriber.

The SCP 50 sets the event of the calling/called terminal by transmitting an “RRB(RequestReportBCSMEvent)” message to the MSC 12 at step 308.

The SCP 50 attempts a call to called terminal B by transmitting a “Connect” message at step 309. The step is performed through the MSC 12.

If the called terminal B is busy, the MSC 12 notifies the SCP 50 of the busy state of the called terminal B by transmitting an “ERB(Busy)” message to the SCP 50 at step 310.

For this, the SCP 50 notifies the program (for example, a messenger program), which has been logged in to and installed in the incoming call information receiving terminal 53 of the called subscriber, of the forwarding of the call by transmitting a “CallEvent” message at step 312. At this time, the information transmitted from the SCP 50 to the incoming call information receiving terminal 53 varies according to the set information of the called subscriber.

The SCP 50 attempts a call to called terminal C by transmitting a “Connect” message to the call forwarding number at step 315. This step is performed through the MSC 12.

If called terminal C answers (O_Answer), the MSC 12 notifies the SCP 50 of the answer state of called terminal C by transmitting an “ERB(O_Answer)” message to the SCP 50 at step 316.

For this, the SCP 50 notifies the program (for example, a messenger program), which has been logged in to and installed in the incoming call information receiving terminal 53 of the called subscriber, of the answer to the call by transmitting “CallEvent” message to the program at step 317. At this time, the information transmitted from the SCP 50 to the incoming call information receiving terminal 53 varies according to the set information of the called subscriber.

When the call is released while calling terminal A is engaged in a call with called terminal C, the MSC 12 notifies the SCP 50 of the termination of the call by transmitting an “ERB(Disconnect)” message to the SCP 50 at step 318.

FIG. 4 is a detailed flowchart illustrating an embodiment of the unconditional call forwarding process of the incoming call information notification method according to the present invention. In this case, the called subscriber sets a call forwarding number to called terminal C for unconditional call forwarding. That is, the incoming call to terminal B is forcibly forwarded to terminal C even if terminal B is busy or if there is no answer.

When calling terminal A attempts a call to service subscriber terminal B at step 402, the calling MSC 12 notifies the SCP 50 of the initiation of the call by transmitting an “InitialDP” message to the SCP 50 according to trigger information set for the called subscriber, at step 403.

Thereafter, the SCP 50 notifies the program (for example, a messenger program), which has been logged in to and installed in the incoming call information receiving terminal 53 of the called subscriber, of the arrival of the call by transmitting “CallEvent(CID)” message to the program at step 405. In this case, the information transmitted from the SCP 50 to the incoming call information receiving terminal 53 varies according to the set information of the called subscriber.

Thereafter, the SCP 50 sets the event of the calling/called terminal by transmitting “RRB(RequestReportBCSMEvent)” message to the MSC 12 at step 408.

The SCP 50 attempts a call to called terminal C by transmitting a “Connect” message to a call forwarding number (unconditional call forwarding number) at step 409. This step is performed through the MSC 12.

If called terminal C answers (O_Answer), the MSC 12 notifies the SCP 50 of the answer of called terminal C by transmitting an “ERB(O_Answer)” message to the SCP 50 at step 410.

For this, the SCP 50 notifies the program (for example, a messenger program), which has been logged in to and installed in the incoming call information receiving terminal 53 of the called subscriber, of the answer to the forwarded call by transmitting a “CallEvent” message to the SCP 50 at step 411. At this time, the information transmitted from the SCP 50 to the incoming call information receiving terminal 53 varies according to the set information of the called subscriber.

When the call is released while calling terminal A is engaged in a call with called terminal C, the MSC 12 notifies the SCP 50 of the termination of the call by transmitting an “ERB(Disconnect)” message to the SCP 50 at step 412.

FIG. 5 is a detailed flowchart illustrating an embodiment of the unconditional voice (/multimedia) mailbox connection process of the incoming call information notification method according to the present invention. In this case, the called subscriber unconditional switches the call to an voice (/multimedia) mailbox and a voice (/multimedia) message is stored therein. That is, the message is forcibly forwarded to the voice (/multimedia) mailbox without being received by terminal B.

When a calling party (calling terminal A) makes a call to the service subscriber terminal B at step 502, the calling MSC 12 notifies the SCP 50 of the initiation of the call by transmitting an “InitialDP” message to the SCP 50 according to trigger information set for the called subscriber, at step 503.

Thereafter, the SCP 50 notifies the program (for example, a messenger program), which has been logged in to and installed in the incoming call information receiving terminal 53 of the called subscriber, of the arrival of the call by transmitting a “CallEvent(CID)” message to the program at step 505. In this case, the information transmitted from the SCP 50 to the incoming call information receiving terminal 53 varies according to the set information of the called subscriber.

Thereafter, the SCP 50 sets a calling/called event by transmitting an “RRB(RequestReportBCSMEvent)” message to the MSC 12 at step 508. The SCP 50 sets a connection to the IP 16 by transmitting an “ETC(EstablishTemporaryConnection)” message to the MSC at step 509.

Then, the MSC 12 receives the ETC message and transmits an “IAM(InitailAddressMessage)” message to the IP 16 at step 510. For this, the IP 16 notifies the SCP 50 that an announcement is ready to be transmitted and played by transmitting an “ARI(AssistRequestInstructions)” message to the MSC 12 at step 511.

Thereafter, the SCP 50 sets an announcement ID in a “PA (PlayAnnouncement)” message and transmits the “PA (PlayAnnouncement)” message to the IP 16 at step 512. For this, the IP 16 transmits a corresponding announcement, which has been set by a subscriber, to a calling party (calling terminal A), and notifies the SCP 50 of the termination of the played announcement by transmitting an “SRR (SpecializedResourceReport)” message to the SCP 50 at step 513.

Thereafter, the SCP 50 causes a message to be recorded by transmitting a “PRM(PromptAndRecordMessage)” message to the IP 16 at step 516, and the IP 16 answers to the recording with a “PRM_ack” message at step 517.

Then, the SCP 50 notifies the program (for example, a messenger program), which has been logged in to and installed in the incoming call information receiving terminal 53 of the called subscriber, of the arrival of the voice (/multimedia) message by transmitting a “CallEvent” message at step 519. In this case, the information transmitted from the SCP 50 to the incoming call information receiving terminal 53 varies according to the set information of the called subscriber.

The SCP 50 causes the call to the IP 16 to be released by transmitting a “connection release(DFC)” message to the MSC 12 at step 521.

FIG. 6 is a detailed flowchart illustrating an embodiment of the call termination process of the incoming call information notification method of the present invention in the case where a called party does not answer. In this case, the called subscriber sets the called number to called terminal B, sets ‘call termination in the case where the called party makes no answer’, and causes forwarding to a voice (/multimedia) mailbox to be performed and the voice (/multimedia) message to be stored, in the case of no answer.

When a calling party (calling terminal A) makes a call to the service subscriber terminal B at step 602, the calling MSC 12 notifies the SCP 50 of the initiation of the call by transmitting an “InitialDP” message to the SCP 50 according to the trigger information set for the called subscriber, at step 603.

Thereafter, the SCP 50 notifies the program (for example, a messenger program), which has been logged in to and installed in the incoming call information receiving terminal 53 of the called subscriber, of the arrival of the call by transmitting a “CallEvent(CID)” message to the program at step 605. In this case, the information transmitted from the SCP 50 to the incoming call information receiving terminal 53 varies according to the set information of the called subscriber.

The SCP 50 sets the event of the calling/called terminal by transmitting an “RRB(RequestReportBCSMEvent)” message to the MSC 12 at step 608.

Furthermore, the SCP 50 attempts a call to the called terminal B by transmitting a “Connect” message to the called number at step 609. This step is performed through the MSC 12.

If the called terminal B does not answer (No_Answer), the MSC 12 notifies the SCP 50 of the lack of answer by the called terminal B by transmitting an “ERB(No_Answer)” message to the SCP 50 at step 610.

For this, the SCP 50 notifies the program (for example, a messenger program), which has been logged in to and installed in the incoming call information receiving terminal 53 of the called subscriber, of no answer state by transmitting a “CallEvent” message to the SCP 50 at step 611. In this case, the information transmitted from the SCP 50 to the incoming call information receiving terminal 53 varies according to the set information of the called subscriber.

Since the called subscriber has set ‘call termination in the case of no answer’, the SCP 50 sets a calling/called event by transmitting an “RRB (RequestReportBCSMEvent)” message to the MSC 12 at step 614, and sets a connection to the IP 16 by transmitting an “ETC (EstablishTemporaryConnection)” message to the MSC 12 at step 615.

Then, the MSC 12 receives the ETC message and transmits an “IAM(InitailAddressMessage)” message to the IP 16 at step 616. For this, the IP 16 notifies the SCP 50 that an announcement is ready to be played by transmitting an “ARI(AssistRequestInstructions)” message to the SCP 50 at step 617.

Thereafter, the SCP 50 sets an announcement ID in a “PA(PlayAnnouncement)” message and transmits the message to the IP 16 at step 618. For this, the IP 16 transmits a corresponding announcement, which has been set by the subscriber, to the calling party (calling terminal A), and then notifies the SCP 50 of the termination of the announcement by transmitting an “SRR(SpecializedResourceReport)” message to the SCP 50 at step 619.

The SCP 50 causes a message to be stored by transmitting a “PRM(PromptAndRecordMessage)” message to the IP 16 at step 622, and the IP 16 answers to the recording through a “PRM_ack” message at step 623.

Then, the SCP 50 notifies the program (for example, a messenger program), which has been logged in to and installed in the incoming call information receiving terminal 53 of the called subscriber, whether the message call has been terminated by transmitting a “CallEvent” message to the program at step 625. Additionally, when the voice (/multimedia) message of the calling party (calling terminal A) is recorded and stored at steps 622˜623, notification of these may be provided.

In the above description, steps “622” to “623” are the steps of recording and storing the voice (/multimedia) of the calling party. It should be noted that these steps are not essential.

FIG. 7 is a detailed flowchart of the call termination process of the incoming call information notification method of the present invention in the case where a called party is busy. In this case, the called subscriber sets the called number to that of called terminal B, sets ‘call termination in the case where the called party is busy’, and causes forwarding to the voice (/multimedia) mailbox to be performed and a voice (/multimedia) message to be stored.

When calling party calling terminal A attempts a call to service subscriber terminal B at step 702, the calling MSC 12 notifies the SCP 50 of the initiation of the call by transmitting an “InitialDP” message to the SCP 50 according to trigger information set for the called subscriber, at step 703.

Thereafter, the SCP 50 notifies the program (for example, a messenger program), which has been logged in to and installed in the incoming call information receiving terminal 53 of the called subscriber, of the arrival of the call by transmitting a “CallEvent(CID)” message to the program at step 705. In this case, the information transmitted from the SCP 50 to the incoming call information receiving terminal 53 varies according to the set information of the called subscriber.

Thereafter, the SCP 50 sets the event of a calling/called terminal by transmitting an “RRB(RequestReportBCSMEvent)” message to the MSC 12 at step 708.

The SCP 50 attempts a call to called terminal B by transmitting a “Connect” message to a called number at step 709. This step is performed through the MSC 12.

If called terminal B is busy, the MSC 12 notifies the SCP 50 that the called terminal B is busy by transmitting an “ERB(Busy)” message to the SCP 50 at step 710.

For this, the SCP 50 notifies the program (for example, a messenger program), which has been logged in to and installed in the incoming call information receiving terminal 53 of the called subscriber, of a no-answer state by transmitting a “CallEvent” message at step 711. At this time, the information transmitted from the SCP 50 to the incoming call information receiving terminal 53 varies according to the set information of the called subscriber.

Since the called subscriber has set ‘call termination in the case of a busy state’, the SCP 50 sets a calling/called event by transmitting an “RRB(RequestReportBCSMEvent)” message to the MSC 12 at step 714, and sets a connection to the IP 16 by transmitting an “ETC(EstablishTemporaryConnection)” message to the MSC 12 at step 715.

Then, the MSC 12 receives the ETC message and transmits an “IAM(InitailAddressMessage)” message to the IP 16 at step 716. For this, the IP 16 notifies the SCP 50 that an announcement is ready to be played by transmitting an “ARI(AssistRequestInstructions)” message to the SCP 50 at step 717.

Thereafter, the SCP 50 sets an announcement ID in a “PA(PlayAnnouncement)” message and transmits the message to the IP 16 at step 718. For this, the IP 16 transmits a corresponding announcement, which has been set by the subscriber, to calling party calling terminal A, and notifies the SCP 50 that the announcement is terminated by transmitting an “SRR(SpecializedResourceReport)” message to the SCP 50 at step 719.

Thereafter, the SCP 50 cause a message to be recorded by transmitting a “PRM(PromptAndRecordMessage)” message to the IP 16 at step 722, and the IP 16 answers to the recording with a “PRM_ack” message at step 723.

Then, the SCP 50 notifies the program (for example, a messenger program), which has been logged in to and installed in the incoming call information receiving terminal 53 of the called subscriber, whether a message call has been terminated by transmitting a “CallEvent” message to the program at step 725. Additionally, when the voice (/multimedia) message of calling party (calling terminal A) is recorded and stored at steps 722˜723, notification of these may be provided.

In the above, steps “722” to “723” are the steps of recording and storing the voice (/multimedia) of the calling party. It should be noted that these steps are not essential.

FIG. 8 is a detailed flowchart of an embodiment of the unconditional call termination of the incoming call information notification method according to the present invention. This is the case where a call is unconditionally terminated without being received by terminal B at the time of the absence of the called subscriber. Accordingly, forwarding to a voice (/multimedia) mailbox is performed without being received by terminal B, and a voice (/multimedia) message is stored.

When a certain calling party calling terminal A makes a call to service subscriber terminal B at step 802, the calling MSC 12 notifies the SCP 50 of the initiation of the call by transmitting an “InitialDP” message to the SCP 50 according to trigger information set for the called subscriber, at step 803.

Thereafter, the SCP 50 notifies the program (for example, a messenger program), which has been logged in to and installed in the incoming call information receiving terminal 53 of the called subscriber, of the arrival of the call by transmitting a “CallEvent(CID)” message to the program at step 805.

Furthermore, since the called subscriber has set ‘unconditional call termination’, the SCP 50 sets a calling/called event by transmitting “RRB (RequestReportBCSMEvent)” message to the MSC 12 at step 808, and sets a connection to the IP 16 by transmitting an “ETC(EstablishTemporaryConnection)” message to the MSC 12 at step 809.

Then, the MSC 12 receives the ETC message and transmits an “IAM(InitailAddressMessage)” message to the IP 16 at step 810. For this, the IP 16 notifies the SCP 50 that an announcement is ready to be played by transmitting an “ARI(AssistRequestInstructions)” message to the SCP 50 at step 811.

Thereafter, the SCP 50 sets an announcement ID in “PA(PlayAnnouncement)” message and transmits the message to the IP 16 at step 812. For this, the IP 16 transmits a corresponding announcement, which has been set by the subscriber, to calling party calling terminal A, and notifies the SCP 50 that the announcement has been terminated by transmitting an “SRR(SpecializedResourceReport)” message to the SCP 50 at step 813.

Thereafter, the SCP 50 causes a message to be recorded by transmitting a “PRM(PromptAndRecordMessage)” message to the IP 16 at step 816, and the IP 16 answers to the recording with a “PRM_ack” message at step 817.

Then, the SCP 50 notifies the program (for example, a messenger program), which has been logged in to and installed in the incoming call information receiving terminal 53 of the called subscriber, whether a message call has been terminated by transmitting a “CallEvent” message at step 819. Additionally, when the voice (/multimedia) message of calling party (calling terminal A) is recorded and stored at steps 816˜817, notification of this may be provided.

In the above description, steps “814” and “817” are steps of recording and storing the voice (/multimedia) of the calling party. It should be noted that these steps are not essential.

Now, the case where a Parlay application server is used instead of an SCP is described with reference to FIGS. 9 to 12.

FIG. 9 is a diagram illustrating an example of the construction of an incoming call information notification system of the present invention, which uses a Parlay application server.

Elements newly added to FIG. 9 are described below.

An SIP application server 36 functions to manage and control call resources to process additional services on an IP network.

A Parlay gateway 40 converts the SS7 protocol to the Parlay or Parlay X API and provides it to the standardized interface of the outside, so as to provide communication network resources to an external service.

A Parlay application server 51 refers to a service application program converged/combined with various environments, such as communication networks and the Internet, while working in conjunction with the Parlay gateway 40.

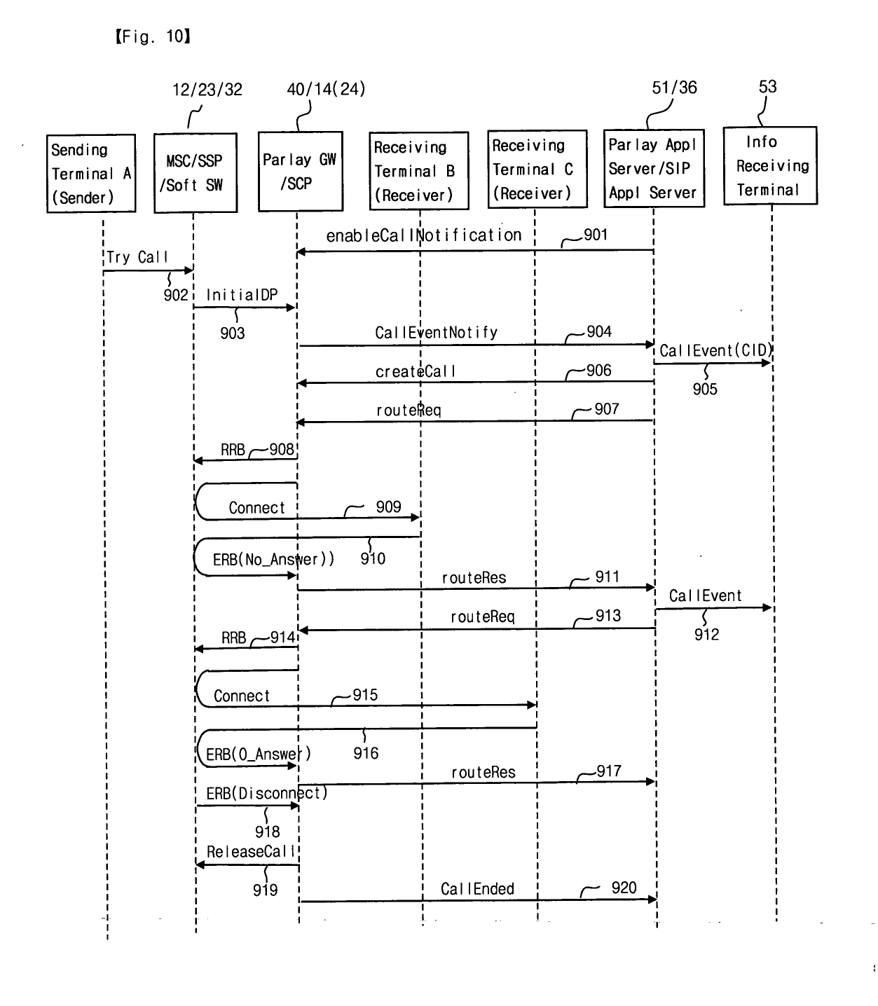

A detailed flowchart of the case where the Parlay application server is used instead of the SCP is described below. Furthermore, although FIGS. 10, 11 and 12, in which SCPs are replaced with Parlay application servers in FIGS. 2, 5 and 6, will be described for ease of description, it will be apparent to those skilled in the art that Parlay application servers can be used instead of SCPs in FIGS. 3, 4, 7 and 8 in the same manner.

FIG. 10 is a detailed flowchart illustrating an embodiment of the call forwarding process of the incoming call information notification method of the present invention in the case where a called party does not answer. In this case, a called subscriber sets a called number to terminal B, sets ‘call forwarding in the case of no answer on a called party’, and sets a call forwarding number to that of terminal C.

First, the Parlay application server 51 sets the trigger information of a subscriber (a call forwarding flag and a called phone number in the case where a called party does not answer) by transmitting an “enableCallNotification” message to the Parlay Gateway 40 at step 901.

Thereafter, when a certain subscriber (calling terminal A) attempts a call to the service subscriber (terminal B) at step 902, the calling MSC 12 notifies the Parlay gateway 40 of the initiation of the call by transmitting an “InitialDP” message to the Parlay gateway 40 according to trigger information set for the called subscriber at step 903. For this, the Parlay gateway 40 notifies the Parlay application server 51 of the initiation of the call according to the trigger information set in the “enableCallNotification” message by transmitting a “CallEventNotify” message to the Parlay application server 51 at step 904.

Thereafter, the Parlay application server 51 notifies the program (for example, a messenger program), which has been logged in to and installed in the terminal 53 of the called subscriber, of the arrival of the call by transmitting a “CallEvent(CID)” message to the program at step 905. At this time, the information transmitted from the Parlay application server 51 to the messenger program varies depending on the set information of the called subscriber.

The Parlay application server 51 notifies the Parlay gateway 40 of the initiation of the call by transmitting a “createCall” message to the Parlay gateway 40 at step 906. Since the called subscriber has set “call forwarding in the case where the called party does not answer”, the Parlay application server 51 requests that a call number be set to ‘called terminal B’ by transmitting a “routeReq” message to the Parlay gateway 40 at step 908.

Thereafter, the Parlay gateway 40 sets the event of the calling/called terminal by transmitting an “RRB (RequestReportBCSMEvent)” to the MSC 12 at step 908.

The Parlay gateway 40 attempts the call to terminal B by transmitting a “Connect” message to the called number of the “routeReq” message at step 909. This step is performed through the MSC 12. That is, when the Parlay gateway 40 transmits the “connect” message to the MSC 12 using the called number of the “routeReq” message, the MSC 12 attempts the call to the corresponding called terminal B.

If the called terminal B does not answer (No_Answer), the MSC 12 notifies the Parlay gateway 40 of the lack of answer by the called terminal B by transmitting an “ERB(EventReportBCSM)(No_Answer)” message to the Parlay gateway 40 at step 910.

Then, the Parlay gateway 40 notifies the Parlay application server 51 of the no-answer information of called terminal B by transmitting a “routeRes” message to the Parlay application server 51 at step 911.

For this, the Parlay application server 51 notifies the program (for example, a messenger program), which has been logged in to and installed in the terminal 53 of the called subscriber, of the forwarding of the call by transmitting a “CallEvent” message to the program at step 912. At this time, the information transmitted from the Parlay application server 51 to the messenger program varies depending on the set information of the called subscriber.

The Parlay application server 51 requests that a call forwarding number be set to ‘called terminal C’ in the case of no answer by transmitting a “routeReq” message to the Parlay gateway 40 at step 913.

Thereafter, the Parlay gateway 40 sets the event of the calling/called terminal by transmitting an “RRB (RequestReportBCSMEvent)” to the MSC 12 at step 914.

Then, the Parlay gateway 40 attempts the call to called terminal C by transmitting a “Connect” message to the call forwarding number of the “routeReq” message at step 915. This step is performed through the MSC 12. That is, when the Parlay gateway 40 transmits the “Connect” message to the MSC 12 using the call forwarding number of the “routeReq” message, the MSC 12 attempts the call to called terminal C.

If called terminal C answers (O_Answer), the MSC 12 notifies the Parlay gateway 40 of the answer state of called terminal C by transmitting an “ERB(O_Answer)” message to the Parlay gateway 40 at step 916.

Then, the Parlay gateway 40 notifies the Parlay application server 51 of the answer information (O_Answer) of called terminal C by transmitting a “routeRes” message to the Parlay application server 51 at step 917.

When the call is released while calling terminal A is engaged in the call with called terminal C, the MSC 12 notifies the Parlay gateway 40 of the termination of the call by transmitting an “ERB(Disconnect)” message to the Parlay gateway 40 at step 918. For this, the Parlay gateway 40 commands the MSC 12 to terminate the corresponding call by transmitting a “ReleaseCall” message to the MSC 12 at step 919, and notifies the Parlay application server of the termination of the call by transmitting a “CallEnded” message to the Parlay application server at step 920.

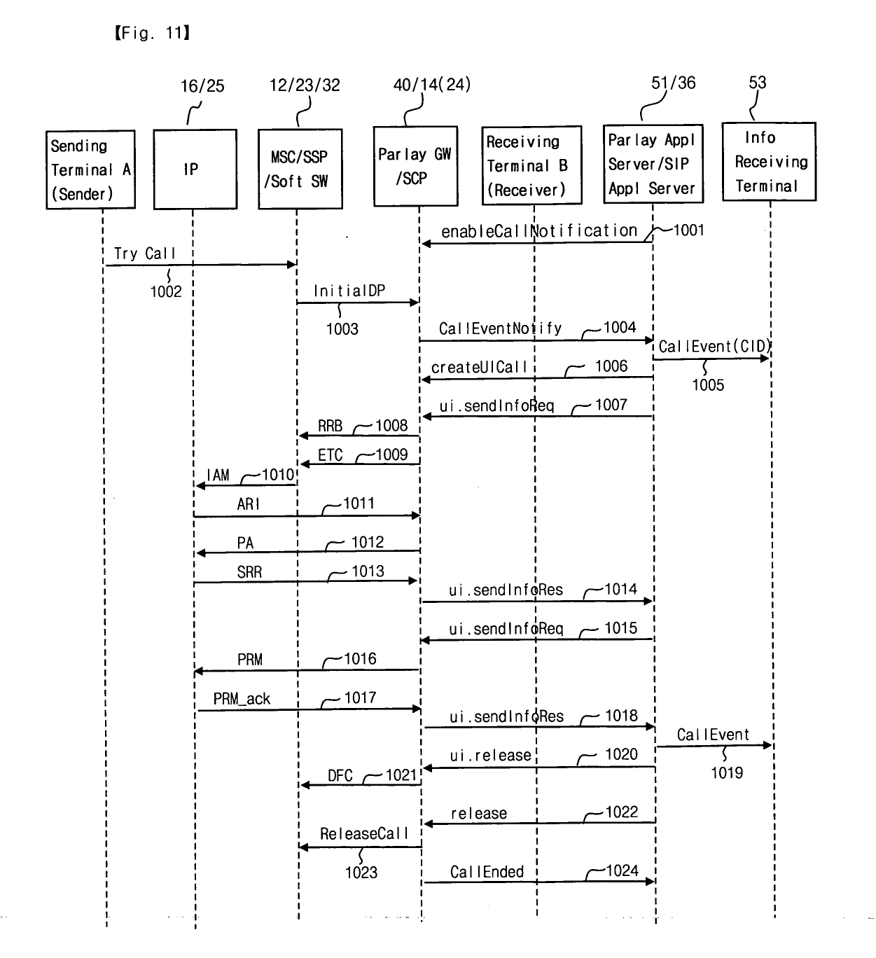

FIG. 11 is a detailed flowchart illustrating an embodiment of the unconditional voice (/multimedia) mailbox connection process of the incoming call information notification method according to the present invention. In this case, the called subscriber is unconditionally switched to a voice (/multimedia) mailbox and a voice (/multimedia) message is stored therein. That is, the message is forcibly forwarded to the voice (/multimedia) mailbox without being received by terminal B.

First, the Parlay application server 51 sets the trigger information of the subscriber (unconditional voice (/multimedia) mailbox connection flag, etc.) by transmitting an “enableCallNotification” message to the Parlay Gateway 40 at step 1001.

Thereafter, when a certain subscriber (calling terminal A) attempts a call to the service subscriber (terminal B) at step 1002, the originating MSC 12 notifies the Parlay gateway 40 of the initiation of the call by transmitting an “InitialDP” message to the Parlay gateway 40 according to trigger information set for a called subscriber at step 1003. For this, the Parlay gateway 40 notifies the Parlay application server 51 of the initiation of the call based on the trigger information set in the “enableCallNotification” message by transmitting a “CallEventNotify” message to the Parlay application server 51 at step 1004.

Thereafter, the Parlay application server 51 notifies the program (for example, a messenger program), which has been logged in to and installed in the incoming call information receiving terminal 53 of the called subscriber, of the arrival of the call by transmitting a “CallEvent(CID)” message to the program at step 1005. In this case, the information transmitted from the Parlay application server 51 to the messenger program varies according to the set information of the called subscriber.

Since the called subscriber has set ‘unconditional voice (/multimedia) mailbox Connection)’, the Parlay application server 51 causes a connection to the IP 16 to be set by transmitting a “createUICall” message to the Parlay gateway 40 at step 1006, and set an announcement ID to be played in “ui.sendInfoReq” message and transmits the message at step 1007.

Thereafter, the Parlay gateway 40 sets a calling/called event by transmitting an “RRB (RequestReportBCSMEvent)” message to the MSC 12 at step 1008. The Parlay gateway 40 sets a connection to the IP 16 by transmitting an “ETC (EstablishTemporaryConnection)” message to the MSC 12 at step 1009.

Then, the MSC 12 receives the ETC message and transmits an “IAM(InitailAddressMessage)” message to the IP 16 at step 1010. For this, the IP 16 notifies the Parlay gateway 40 that an announcement is ready to be played by transmitting an “ARI(AssistRequestInstructions)” message to the Parlay gateway 40 at step 1011.

Thereafter, the Parlay gateway 40 sets an announcement ID, which is received from a “ui.sendinfoReq” message, in the “PA(PlayAnnouncement)” message and transmits the message to the IP 16 at step 1012. For this, the IP 16 transmits a corresponding announcement, which has been set by the subscriber, to the calling party (calling terminal A), and then notifies the Parlay gateway 40 of the termination of the announcement by transmitting an “SRR (SpecializedResourceReport)” message to the Parlay gateway 40 at step 1013.

Thereafter, the Parlay gateway 40 sets the results to the “SRR(SpecializedResourceReport)” message in a “ui.sendinforRes” message and transmits the message to the Parlay application server 51 at step 1014. For this, the Parlay application server 51 causes message recording to be initiated by transmitting a “ui.sendInfoReq” message to the Parlay gateway 40 at step 1015.

Thereafter, the Parlay gateway 40 causes message recording to be initiated by transmitting a “PRM(PromptAndRecordMessage)” message to the IP 16 at step 1016, and the IP 16 answers to the recording with a “PRM_ack” message at step 1017.

Then, the Parlay gateway 40 sets the results to the SRR message in a “ui.sendinforRes” message and transmits the message to the Parlay application server 51 at step 1018. The Parlay application server 51 notifies the program (for example, a messenger program), which has been logged in to and installed in the incoming call information receiving terminal 53 of the called subscriber, of the arrival of the voice (/multimedia) message by transmitting a “CallEvent” message to the program at step 1019. In this case, the information transmitted from the Parlay application server 51 to the messenger program varies according to the set information of the called subscriber.

The Parlay application server 51 causes the Parlay gateway 40 to terminate the call with the IP 16 by transmitting a “ui.release” message to the Parlay gateway 40 at step 1020. For this, the Parlay gateway 40 causes the MSC 12 to terminate the call with the IP 16 by transmitting a “connection release(DFC)” message to the MSC 12 at step 1021.

Furthermore, the Parlay application server 51 causes the Parlay gateway 40 to terminate the call by transmitting a “release” message to the Parlay gateway 40 at step 1022, and the Parlay gateway 40 commands the MSC 12 to terminate the corresponding call by transmitting a “ReleaseCall” message to the MSC 12 at step 1023, and notifies the Parlay application server 51 of the termination of the call by transmitting a “CallEnded” message to the Parlay application server 51 at step 1024.

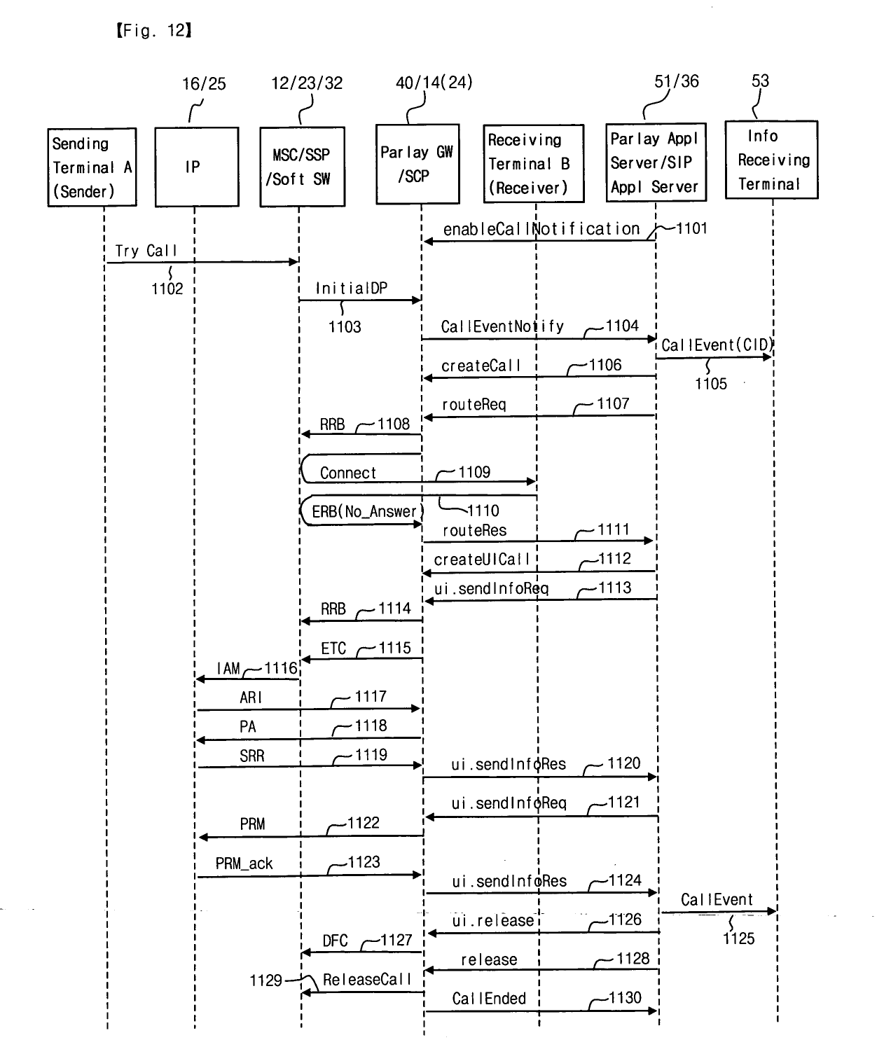

FIG. 12 is a detailed flowchart illustrating an embodiment of the voice (/multimedia) mailbox connection process of the incoming call information notification method of the present invention in the case where a called party does not answer. In this case, the called subscriber sets a called number to that of called terminal B, and sets “connection to a voice (/multimedia) mailbox in the case where called party does not answer”, so that switching to the voice (/multimedia) mailbox is performed when there is no answer and a voice (/multimedia) message is stored therein.

First, the Parlay application server 51 sets the trigger information of the subscriber (call termination flag in the case of no answer from called party, etc.) by transmitting an “enableCallNotification” message to the Parlay Gateway 40 at step 1101.

Thereafter, when a certain subscriber (calling terminal A) attempts a call to the service subscriber (terminal B) at step 1102, the calling MSC 12 notifies the Parlay gateway 40 of the initiation of the call by transmitting an “InitialDP” message to the Parlay gateway 40 according to trigger information set for a called subscriber at step 1103. For this, the Parlay gateway 40 notifies the Parlay application server 51 of the initiation of the call based on the trigger information set in the “enableCallNotification” message by transmitting a “CallEventNotify” message to the Parlay application server 51 at step 1104.

Thereafter, the Parlay application server 51 notifies the program (for example, a messenger program), which has been logged in to and installed in the incoming call information receiving terminal 53 of the called subscriber, of the arrival of the call by transmitting a “CallEvent(CID)” message to the program at step 1105. In this case, the information transmitted from the Parlay application server 51 to the messenger program varies according to the set information of the called subscriber.

The Parlay application server 51 notifies the Parlay gateway 40 of the initiation of the call by transmitting a “createcall” message to the Parlay gateway 40 at step 1106. Since the called subscriber has set “call termination in the case of no answer”, the Parlay application server 51 requests the Parlay gateway 40 to set a called number to that of ‘called terminal B’ by transmitting a “routeReq” message to the Parlay gateway 40 at step 1107.

Thereafter, the Parlay gateway 40 sets the event of a calling/called terminal by transmitting an “RRB (RequestReportBCSMEvent)” message to the MSC 12 at step 1108.

The Parlay gateway 40 attempts the call to terminal B by transmitting a “Connect” message to the called number of the “routeReq” message at step 1109. This step is performed through the MSC 12. That is, when the Parlay gateway 40 transmits the “Connect” message to the MSC 12 using the called number of the “routeReq” message, the MSC 12 attempts the call to a corresponding called terminal B.

If the called terminal B does not answer (No_Answer), the MSC 12 notifies the Parlay gateway 40 of the no-answer state of the called terminal B by transmitting an “ERB(No_Answer)” message to the Parlay gateway 40 at step 1110.

Then, the Parlay gateway 40 notifies the Parlay application server 51 of the no-answer information (No_Answer) of terminal B by transmitting a “routeRes” message to the Parlay application server 51 at step 1111.

Since the called subscriber has set “call termination in the case of no answer”, the Parlay application server 51 causes a connection to the IP 16 to be set by transmitting a “createUICall” message to the Parlay gateway 40 at step 1112, and sets an announcement ID to be played in the “ui.sendinfoReq” message and transmits the message at step 1113.

Thereafter, the Parlay gateway 40 sets a calling/called event by transmitting an “RRB (RequestReportBCSMEvent)” message to the MSC 12 at step 1114. The Parlay gateway 40 sets a connection to the IP 16 by transmitting an “ETC (EstablishTemporaryConnection)” message to the MSC 12 at step 1115.

Then, the MSC 12 receives the ETC message and transmits an “IAM(InitailAddressMessage)” message to the IP 16 at step 1116. For this, the IP 16 notifies the Parlay gateway 40 that an announcement is ready to be played by transmitting an “ARI(AssistRequestInstructions)” message to the Parlay gateway 40 at step 1117.

Thereafter, the Parlay gateway 40 sets the announcement ID, which is received from a “ui.sendinfoReq” message, in the “PA(PlayAnnouncement)” message and transmits the message to the IP 16 at step 1118. For this, the IP 16 transmits a corresponding announcement, which has been set by the subscriber, to the calling party (calling terminal A), and then notifies the Parlay gateway 40 of the termination of the announcement played by transmitting an “SRR(SpecializedResourceReport)” message to the Parlay gateway 40 at step 1119.

Thereafter, the Parlay gateway 40 sets the results to the “SRR(SpecializedResourceReport)” message in the “ui.sendinfoRes” message and transmits the message to the Parlay application server 51 at step 1120. For this, the Parlay application server 51 causes message recording to be initiated by transmitting a “ui.sendInfoReq” message to the Parlay gateway 40 at step 1121.

Thereafter, the Parlay gateway 40 causes message recording to be initiated by transmitting a “PRM(PromptAndRecordMessage)” message to the IP 16 at step 1122, and the IP 16 answers to the recording with a “PRM_ack” message at step 1123.

Then, the Parlay gateway 40 sets the results of SRR message in the “ui.sendinforRes” message and transmits the message to the Parlay application server 51 at step 1124, and the Parlay application server 51 notifies the program (for example, a messenger program), which has been logged in to and installed in the incoming call information receiving terminal 53 of the called subscriber, of whether a message call has been terminated by transmitting a “CallEvent” message to the program at step 1125. Additionally, when the voice (/multimedia) message of the calling party (calling terminal A) is recorded and stored at steps 1120˜1123, notification of these may be provided. In this case, the information transmitted from the Parlay application server 51 to the messenger program varies according to the set information of the called subscriber.

The Parlay application server 51 causes the Parlay gateway 40 to terminate the call with the IP 16 by transmitting a “ui.release” message to the Parlay gateway 40 at step 1126. For this, the Parlay gateway 40 causes the MSC 12 to terminate the call with the IP 16 by transmitting a “connection release(DFC)” message to the MSC 12 at step 1127.

Furthermore, the Parlay application server 51 causes the Parlay gateway 40 to terminate the call by transmitting a “release” message to the Parlay gateway 40 at step 1128, and the Parlay gateway 40 commands the MSC 12 to terminate the corresponding call by transmitting a “ReleaseCall” message to the MSC 12 at step 1129, and notifies the Parlay application server 51 of the termination of the call by transmitting a “CallEnded” message to the Parlay application server 51 at step 1130.

In the above description, steps “1120” to “1123” are the steps of recording and storing the voice (/multimedia) of the calling party. It should be noted that these steps are not essential.

The present invention described above has an advantage in that it allows termination trigger service to be easily and efficiently used by notifying the program of the incoming call information receiving terminal of a called party, which is connected to the Internet, of incoming call information (‘incoming call information notification service’) at the time of receiving a call using a termination trigger being used in an existing communication network.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. An incoming call information notification method in an incoming call information notification system, comprising the steps of:
a subscriber setting a call forwarding condition that call forwarding be performed when a called terminal does not answer or is busy, and setting an incoming call information receiving terminal, for an intelligent network;
the intelligent network notifying the incoming call information receiving terminal of arrival of a call at the called terminal when a calling party attempts the call to the called terminal;
the intelligent network attempting the call to the called terminal; and
if, as a result of the attempt, the intelligent network receives information about a lack of answer or a busy state, the intelligent network notifying the incoming call information receiving terminal of call forwarding.

2. An incoming call information notification method in an incoming call information notification system, comprising the steps of:
a subscriber setting a call forwarding condition that call forwarding be unconditionally performed, and setting an incoming call information receiving terminal, for an intelligent network;
the intelligent network notifying the incoming call information receiving terminal of the arrival of a call at the called terminal when a calling party attempts the call to the called terminal; and
the intelligent network attempting to forward the call to the incoming call information receiving terminal.

3. An incoming call information notification method in an incoming call information notification system, comprising the steps of:
a subscriber setting an incoming call information receiving terminal for an intelligent network;
the intelligent network notifying the incoming call information receiving terminal of the arrival of a call at a called terminal when a calling party attempts the call to the called terminal;
the intelligent network forwarding the call to a mailbox; and
after processing a message in the mailbox, the intelligent network notifying the incoming call information receiving terminal of arrival of the message.

4. An incoming call information notification method in an incoming call information notification system, comprising the steps of:
a subscriber setting a call termination condition that call termination be performed when a called terminal does not answer or is busy, and setting an incoming call information receiving terminal, for an intelligent network;
the intelligent network notifying the incoming call information receiving terminal of arrival of a call at the called terminal when a calling party attempts the call to the called terminal;
the intelligent network attempting the call to the called terminal; and
if, as a result of the attempt, the intelligent network receives information about a lack of answer or a busy state, the intelligent network transmitting an announcement to a calling terminal.

5. An incoming call information notification method in an incoming call information notification system, comprising the steps of:
a subscriber setting a call termination condition that call termination be unconditionally performed, and setting an incoming call information receiving terminal, for an intelligent network;
the intelligent network notifying the incoming call information receiving terminal of arrival of a call at the called terminal when a calling party attempts the call to the called terminal; and
the intelligent network transmitting an announcement to a calling terminal.

6. The incoming call information notification method as set forth in any one of claims 1 to 5, wherein the step of providing notification of the arrival of the call is performed in such a way that the intelligent network ascertains a phone number of the calling party and works in conjunction with a client information program in the incoming call receiving terminal to display detailed information about the calling party on the incoming call receiving terminal.

7. The incoming call information notification method as set forth in claim 4 or 5, further comprising the step of recording a message from the calling party.

8. The incoming call information notification method as set forth in any one of claims 1 to 5, wherein the intelligent network uses a service control point.

9. The incoming call information notification method as set forth in any one of claims 1 to 5, wherein the intelligent network uses a Parlay gateway and an Parlay application server.

10. The incoming call information notification method as set forth in any one of claims 1 to 5, wherein the incoming call information receiving terminal is a terminal that is connected to an Internet.

11. The incoming call information notification method as set forth in any one of claims 1 to 5, wherein the incoming call information receiving terminal is a mobile communication terminal.

12. The incoming call information notification method as set forth in any one of claims 1 to 5, wherein the incoming call information receiving terminal is a soft phone for Voice over Internet Protocol (VoIP).
